(19) United States
(12) Patent Application Publication
(10) Pub. No.: US 2025/0259648 A1
(43) Pub. Date: Aug. 14, 2025

(54) DISK DRIVE SUSPENSION STRUCTURE AND DISK DRIVE

(71) Applicant: NHK SPRING CO., LTD., Yokohama-shi (JP)

(72) Inventor: Tatsuhiko NISHIDA, Yokohama-shi (JP)

(73) Assignee: NHK SPRING CO., LTD., Yokohama-shi (JP)

(21) Appl. No.: 19/032,571

(22) Filed: Jan. 21, 2025

(30) Foreign Application Priority Data
Feb. 9, 2024 (JP) 2024-018584

(51) Int. Cl. G11B 5/48

(52) U.S. Cl. CPC G11B 5/4833; G11B 5/4826

(57) ABSTRACT

According to one embodiment, a disk drive suspension structure includes a base member including a base portion and an attachment portion connected to the base portion, the base portion including a boss portion attached to the arm, the attachment portion including a first attachment surface facing in a direction opposite to a projection direction of the boss portion and a second attachment surface facing in the projection direction of the boss portion, a first load beam attached to the first attachment surface, and a second load beam attached to the second attachment surface and facing the first load beam.

### CROSS-REFERENCE TO RELATED APPLICATIONS

This application is based upon and claims the benefit of priority from prior Japanese Patent Application No. 2024-018584, filed Feb. 9, 2024, the entire contents of which are incorporated herein by reference.

### BACKGROUND OF THE INVENTION

### 1. Field of the Invention

The present invention relates to a disk drive suspension structure and a disk drive.

### 2. Description of the Related Art

Hard disk drives (HDDs) are used in information processing apparatuses such as computers. A hard disk drive includes a magnetic disk which rotates around a spindle, a carriage which turns on a pivot, and the like. The carriage comprises an arm and is turned on the pivot in a track-width direction of the disk by a positioning motor such as a voice coil motor.

A disk drive suspension (hereinafter, simply referred to as a suspension) is attached to the arm. The suspension includes a baseplate connected to the arm, a load beam, a flexure disposed along the load beam, and the like. A slider constituting a magnetic head is provided at a gimbal portion formed in the vicinity of the distal end of the flexure.

The slider is provided with elements (transducers) for accessing data, that is, for reading or writing data. The load beam, the flexure, the slider, and the like, constitute a head gimbal assembly.

In order to deal with an increase in the recording density of a disk, the head gimbal assembly needs to be more smaller and be positioned on the recording surface of the disk more precisely.

There has been a strong demand to improve the recording capacity of hard disk drives to deal with an improvement in the recording density. Thus, increasing the number of magnetic disks in the hard disk drives (that is, configuring them for multiple disks) has been underway. To increase the number of magnetic disks, it is necessary to reduce the distance between the magnetic disks, as well as making the magnetic disks and the like thinner.

For example, reducing the thickness of an arm to reduce the distance between the magnetic disks has been known. As means for reducing the thickness of an arm, various proposals have been made (for example, JP 2736174 B, US 2021/0264941 A, and JP H07-111771 B).

However, even in light of the inventions disclosed in the above patent literatures, there is still room for various improvements in making disk drives thinner.

### BRIEF SUMMARY OF THE INVENTION

One of the objects of the present invention is to provide a disk drive suspension structure and a disk drive which can be made thinner.

According to one embodiment, a disk drive suspension structure attached to an arm of a disk drive. The disk drive suspension structure comprises a base member comprising a base portion and an attachment portion connected to the base portion, the base portion comprising a boss portion attached to the arm, the attachment portion comprising a first attachment surface facing in a direction opposite to a projection direction of the boss portion and a second attachment surface facing in the projection direction of the boss portion, a first load beam attached to the first attachment surface, and a second load beam attached to the second attachment surface and facing the first load beam.

The first load beam may comprise first bent portions formed at both side portions of the first load beam, respectively, and extending in a longitudinal direction of the first load beam. The second load beam may comprise second bent portions formed at both side portions of the second load beam, respectively, extending in the longitudinal direction, and facing the first bent portions.

The base portion comprises a first surface on which the boss portion is formed and which faces the arm. The second attachment surface may be shifted further in the projection direction than the first surface.

The base portion further may comprise a second surface on an opposite side of the first surface, and the first attachment surface may be shifted further in the projection direction than the second surface.

The base member further may comprise a step portion formed between the base portion and the attachment portion. The step portion may comprise a first inclined surface connecting the first surface and the second attachment surface, and a second inclined surface connecting the second surface and the first attachment surface.

The base member may comprise a first member comprising the first attachment surface, and a second member comprising the boss portion and the second attachment surface and overlapping the first member. The second member may comprise a third surface not overlapping the first member, and a fourth surface connected to the third surface and facing the first member. The third surface and the fourth surface may be located on an opposite side of the second attachment surface.

The base member may comprise a third member comprising the boss portion and the first attachment surface, and a fourth member comprising the second attachment surface and overlapping the third member. The fourth member and the boss portion may be arranged in the longitudinal direction of the first load beam.

The first load beam may comprise a first spring portion attached to the first attachment surface, and a first load bent portion formed in a width direction of the first load beam between the first spring portion and the first bent portions and having a first angle. The second load beam may comprise a second spring portion attached to the second attachment surface, and a second load bent portion formed in the width direction between the second spring portion and the second bent portions and having a second angle different from the first angle.

The second angle may be smaller than the first angle. The second attachment surface may be inclined with respect to the first attachment surface to increase a distance between the first attachment surface and the second attachment surface in a longitudinal direction of the first load beam.

The first load beam may comprise first bent portions formed at both side portions of the first load beam, respectively, and extending in a longitudinal direction of the first load beam. The second load beam may comprise second bent portions formed at both side portions of the second load beam, respectively, and extending in the longitudinal direction, a gap being formed between the first bent portions and the second bent portions in a width direction of the first load beam. The first bent portions may overlap the second bent portions, when viewed in the width direction.

The base member further may comprise an actuator mounting portion formed between the first attachment surface and the second attachment surface. The actuator mounting portion may be an aperture penetrating the first attachment surface and the second attachment surface.

According to one embodiment, a disk drive comprises the disk drive suspension structure, and the arm comprising a base fixing portion to which the base member is attached.

The above-described structures can provide a disk drive suspension structure and a disk drive which can be made thinner.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view illustrating an example of a disk drive according to a first embodiment.

FIG. 2 is a schematic cross-sectional view illustrating part of the disk drive according to the first embodiment.

FIG. 3 is a schematic partial enlarged view illustrating the vicinity of the distal end portion of an arm illustrated in FIG. 2.

FIG. 4 is a schematic cross-sectional view of a suspension structure along line IV-IV of FIG. 3.

FIG. 5 is a schematic plan view illustrating an example of the suspension structure according to the first embodiment.

FIG. 6 is a schematic partial enlarged view illustrating the vicinity of the distal end portion of an arm of a disk drive according to a comparative example.

FIG. 7 is a diagram illustrating the arrangement state of a head stack assembly and disks in the disk drive according to the comparative example.

FIG. 8 is a diagram illustrating the arrangement state of a head stack assembly and disks in the disk drive according to the first embodiment.

FIG. 9 is a schematic partial enlarged view illustrating the vicinity of the distal end portion of the arm in the disk drive according to a second embodiment.

FIG. 10 is a schematic partial enlarged view illustrating the vicinity of the distal end portion of the arm in the disk drive according to a third embodiment.

FIG. 11 is a schematic partial enlarged view illustrating the vicinity of the distal end portion of the arm in the disk drive according to a fourth embodiment.

FIG. 12 is a schematic partial enlarged view illustrating the vicinity of the distal end portion of the arm in the disk drive according to a fifth embodiment.

FIG. 13 is a schematic partial enlarged view illustrating the vicinity of the distal end portion of the arm in the disk drive according to a sixth embodiment.

FIG. 14 is a schematic partial enlarged view illustrating the vicinity of the distal end portion of the arm in the disk drive according to a seventh embodiment.

FIG. 15 is a diagram illustrating an example of the arrangement state of load beams of the suspension structure in the seventh embodiment.

FIG. 16 is a diagram illustrating another example of the arrangement state of the load beams of the suspension structure in the seventh embodiment.

FIG. 17 is a schematic partial enlarged view illustrating the vicinity of the distal end portion of the arm in the disk drive according to an eighth embodiment.

FIG. 18 is a schematic partial enlarged view illustrating the vicinity of the distal end portion of the arm in the disk drive according to a ninth embodiment.

FIG. 19 is a schematic plan view illustrating an example of the suspension structure according to a tenth embodiment.

FIG. 20 is a schematic partial enlarged view illustrating the vicinity of the distal end portion of the arm in the disk drive according to the tenth embodiment.

### DETAILED DESCRIPTION OF THE INVENTION

Each embodiment of the present invention will be described hereinafter with reference to the drawings. To make the description clearer, the drawings may schematically illustrate the size, the shape, and the like, of each portion, with changes from those in actual embodiments.

The drawings illustrate an X-axis, a Y-axis, and a Z-axis orthogonal to each other to facilitate understanding as necessary. A direction along the X-axis is referred to as a first direction X, a direction along the Y-axis is referred to as a second direction Y, and a direction along the Z-axis is referred to as a third direction Z. The third direction Z may be referred to “high” or “upward”, and the direction opposite to the third direction Z may be referred to as “low” or “downward”.

### FIRST EMBODIMENT

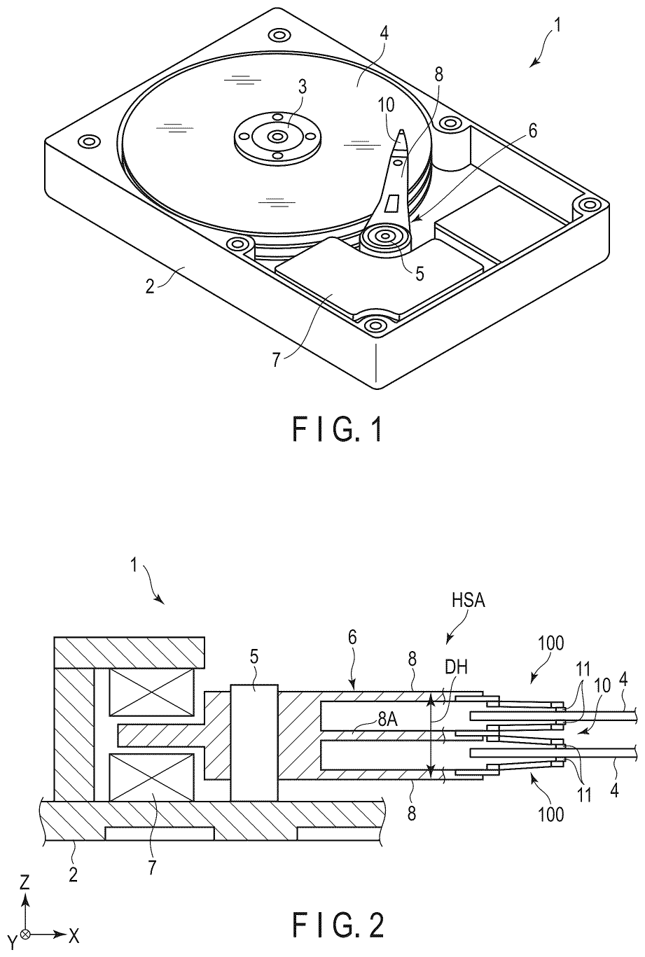

FIG. 1 is a schematic perspective view illustrating an example of a disk drive 1 (HDD) according to the present embodiment. In the example illustrated in FIG. 1, the disk drive 1 comprises a case 2, magnetic disks 4 (hereinafter, simply referred to as disks 4) which rotate around a spindle 3, a carriage 6 which can turn on a pivot 5, and a positioning motor (voice coil motor) 7 for actuating the carriage 6. The case 2 is sealed by a lid not illustrated in the figure.

FIG. 2 is a schematic cross-sectional view illustrating part of the disk drive 1 according to the present embodiment. The carriage 6 comprises arms 8 (for example, three arms 8). A disk drive suspension structure 10 (hereinafter, simply referred to as a suspension structure 10) is attached to the distal end portion of the arm 8 provided in the central portion of the arms 8.

In the following description, the arm 8 to which the suspension structure 10 is attached, of the arms 8, is referred to as an arm 8A. In addition, disk drive suspensions 100 (hereinafter, simply referred to as suspensions 100) are attached to the distal end portions of the other arms 8, respectively.

Sliders 11 constituting a magnetic head are mounted on the distal end portions of the suspension structure 10 and the suspensions 100, respectively. Two sliders 10 are mounted on the one suspension structure 10. In contrast, one slider 11 is mounted on each of the suspensions 100.

As illustrated in FIG. 2, the disks 4 (for example, two disks 4) face each other at a predetermined distance. The suspension structure 10 is located between two disks 4. The carriage 6, the suspension structure 10, the suspensions 100, and the like constitute a head stack assembly HSA.

When the disks 4 rotate at high speed, an influx of air into the space between the disks 4 and the sliders 11 forms an air bearing. When the carriage 6 is turned by the positioning motor 7, the arms 8 move in the radial direction of the disks 4, and the sliders 11 thereby move to desired tracks on the disks 4.

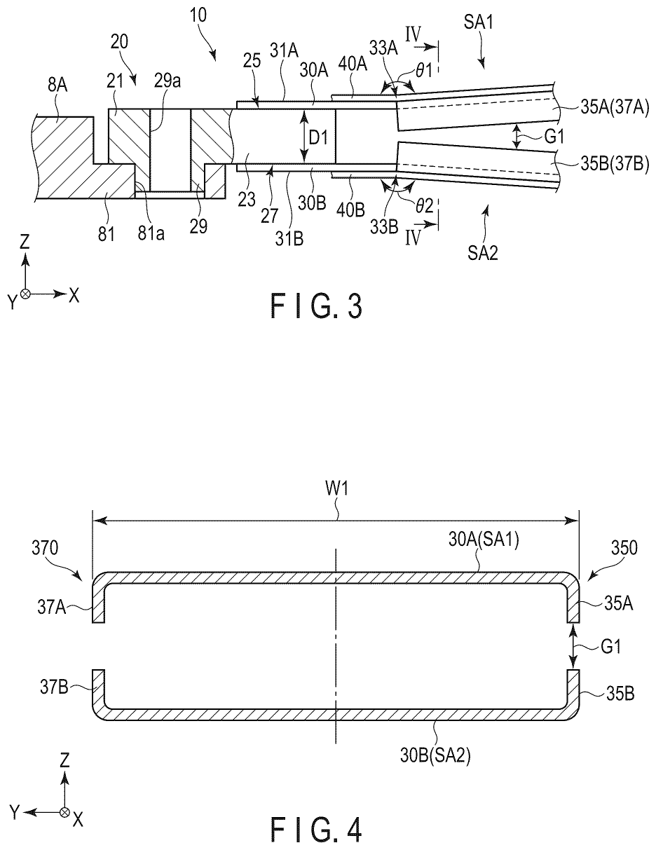

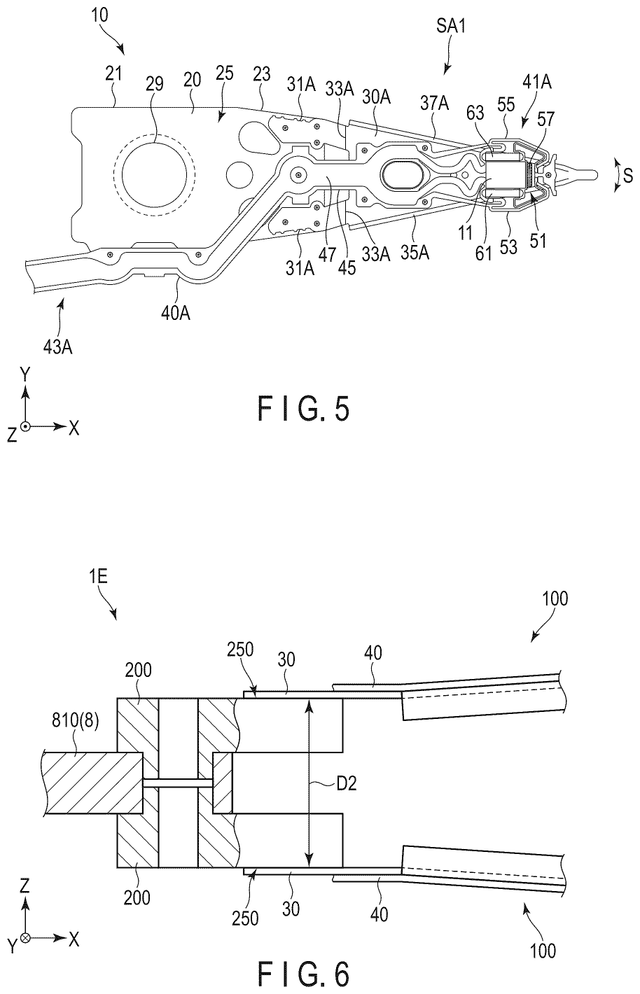

FIG. 3 is a schematic partial enlarged view illustrating the vicinity of the distal end portion of the arm 8A illustrated in FIG. 2. FIG. 4 is a schematic cross-sectional view of the suspension structure 10 along line IV-IV of FIG. 3. FIG. 5 is a schematic plan view illustrating an example of the suspension structure 10 according to the present embodiment.

In FIG. 3, some portions are illustrated in cross-sectional view. In FIG. 4, only load beams 30A and 30B are illustrated. In FIG. 5, the suspension structure 10 is viewed in the direction opposite to the third direction Z.

As illustrated in FIG. 3, the suspension structure 10 is attached to the arm 8A. The arm 8A comprises a base fixing portion 81 at its distal end portion. In the example illustrated in FIG. 3, the base fixing portion 81 has a thickness smaller than that of the other portion.

In the base fixing portion 81, a through-hole 81a for passing a boss portion, which will be described later, is formed. The carriage 6 (illustrated in FIG. 2) including the arm 8A is formed of, for example, a metallic material such as an aluminum alloy.

The suspension structure 10 extends in the first direction X. In the present embodiment, the first direction X corresponds to the longitudinal direction of the suspension structure 10. In the first direction X, the side on which the sliders 11 are mounted with respect to the arms 8 is referred to as the “distal end side”.

The second direction Y corresponds to the width direction of the suspension structure 10, and the third direction Z corresponds to the thickness direction of the suspension structure 10. In the following description, a distance along the third direction Z may be referred as a “thickness”.

The suspension structure 10 comprises a base member 20 and suspension elements SA1 and SA2. The base member 20 is attachable to the base fixing portion 81 of the arm 8A. The base member 20 has the shape of a plate.

The base member 20 comprises a base portion 21 and an attachment portion 23 connected to the base portion 21. The base portion 21 corresponds to, for example, a portion overlapping the arm 8A.

The base member 20 comprises a surface 25 and a surface 27 on the opposite side of the surface 25. In the present embodiment, the surface 25 corresponds to a first attachment surface, and the surface 27 corresponds to a second attachment surface. Each of the surfaces 25 and 27 is formed over the base portion 21 and the attachment portion 23. The surface 25 faces in the third direction Z, and the surface 27 faces in the direction opposite to the third direction Z.

The surfaces 25 and 27 are parallel to an X-Y plane defined by the first direction X and the second direction Y. When the focus is on the arm 8A, the surface 27 includes a region facing the arm 8A.

The base portion 21 comprises a boss portion 29. The base member 20 is attached to the arm 8A via the boss portion 29. In the example illustrated in FIG. 3, the boss portion 29 is formed on the surface 27 in the base portion 21.

The boss portion 29 projects from the surface 27 in the direction opposite to the third direction Z. In the present embodiment, the third direction Z corresponds to the direction opposite to the projection direction of the boss portion 29, and the direction opposite to the third direction Z corresponds to the projection direction of the boss portion 29.

The boss portion 29 has, for example, a circular shape when viewed in the third direction Z. In the boss portion 29, a through-hole 29a for passing a ball for swaging is formed.

The thickness of the base member 20 is, for example, 300 μm or less. For example, the thickness of the base member 20 is 100 to 300 μm. However, the thickness of the base member 20 is not limited to the above example. The thickness of the base member 20 corresponds to the distance between the surface 25 and the surface 27. The thickness of the base member 20 is, for example, smaller than the thickness of the arms 8. Here, the thickness of the arms 8 is the thickness of the portions other than the base fixing portion 81.

The base member 20 is formed of, for example, a metallic material such as stainless steel. In the present embodiment, the base member 20 is formed of a single member.

The suspension elements SA1 and SA2 are each attached to the base member 20. The suspension element SA1 faces the suspension element SA2 with the base member 20 interposed therebetween.

The suspension element SA2 has the same structure as that of the suspension element SA1. The description here mainly explains the structure of the suspension element SA1.

The suspension element SA1 comprises the load beam 30A (first load beam) and a flexure 40A. The load beam 30A is attached to the surface 25 of the base member 20. As illustrated in FIG. 5, the load beam 30A has a shape tapering toward the distal end side.

The load beam 30A comprises a spring portion 31A (first spring portion). The load beam 30A is elastically supported on the surface 25 by the spring portion 31A. The load beam 30A is, for example, fixed to the surface 25 by spot welding using a laser.

The load beam 30A further comprises a load bent portion 33A (first load bent portion) and bent portions 35A and 37A (first bent portions). As illustrated in FIG. 3, the load beam 30A is inclined by the load bent portion 33A in a direction crossing the first direction X, when viewed in the second direction Y.

The load bent portion 33A is located between the spring portion 31A and the bent portions 35A and 37A in the first direction X. The load bent portion 33A is formed along the second direction Y. The load bent portion 33A has a first angle θ1.

The first angle θ1 of the load bent portion 33A is, for example, a clockwise angle with respect to the spring portion 31A, when viewed in the second direction Y. In FIG. 3, the load beam 30A is inclined upward in the first direction X.

The bent portions 35A and 37A are provided closer to the distal end side than the load bent portion 33A. As illustrated in FIG. 4, the bent portions 35A and 37A are formed at both side portions 350 and 370 of the load beam 30A. Both side portions 350 and 370 of the load beam 30A are portions located at both sides in the second direction Y of the load beam 30A. The bent portions 35A and 37A extend in the first direction X. In the load beam 30A, the stiffness of the region where the bent portions 35A and 37A are formed is greater than that of the other regions.

The thickness of the load beam 30A is smaller than the thickness of the base member 20. The thickness of the load beam 30A is, for example, 20 to 80 um, but is not limited to this example. The load beam 30A is formed of a metallic material such as stainless steel.

As illustrated in FIG. 5, the flexure 40A is disposed along the base member 20 and the load beam 30A. Part of the flexure 40A overlaps the load beam 30A. The flexure 40A is, for example, fixed to the base member 20 and the load beam 30A by spot welding using a laser.

The flexure 40A includes a distal end side portion 41A overlapping the load beam 30A and a flexure tail 43A extending from the distal end side portion 41A toward the back of the base member 20.

The flexure 40A comprises a metal base 45 formed of, for example, a thin plate of stainless steel, and a wiring portion 47 overlapping the metal base 45. The thickness of the metal base 45 is smaller than the thickness of the load beam 30A. The thickness of the metal base 45 is, for example, 15 to 20 μm.

In the distal end side portion 41A, the flexure 40A further comprises a tongue 51 and a pair of outriggers 53 and 55. On the tongue 51, the slider 11 is mounted.

The distal end portion of the slider 11 is provided with elements which can convert a magnetic signal and an electrical signal, for example, MR elements. In the distal end side portion 41A, the wiring portion 47 is electrically connected to the elements of the slider 11 via a terminal 57. The elements access the disk 4, that is, writes data to or read data from the disk 4.

The pair of outriggers 53 and 55 is disposed at both sides of the tongue 51 in the second direction Y, respectively. The pair of outriggers 53 and 55 has a shape protruding to both outer sides of the tongue 51 in the second direction Y. All of the tongue 51 and the pair of outriggers 53 and 55 are part of the metal base 45, and their respective contours are formed by, for example, etching.

The tongue 51, the pair of outriggers 53 and 55, and the like constitute a gimbal portion. The gimbal portion is formed at the distal end side portion 41A of the flexure 40A. On the gimbal portion, actuator elements 61 and 63 are mounted. The actuator elements 61 and 63 have the function of pivoting the tongue 51 in a sway direction S (illustrated in FIG. 5).

The actuator elements 61 and 63 are disposed at both sides of the slider 11 in the second direction Y. The actuator elements 61 and 63 are, for example, piezoelectric elements, and are formed of lead zirconate titanate (PZT) or the like. The actuator elements 61 and 63 are each fixed to the tongue 51 by conductive adhesive or the like.

As illustrated in FIG. 3, the suspension element SA2 comprises the load beam 30B (second load beam) and a flexure 40B. The load beam 30B and the flexure 40B have the same structures as those of the load beam 30A and the flexure 40A.

The load beam 30B is attached to the surface 27 of the base member 20. The load beam 30B faces the load beam 30A. The load beam 30B comprises a spring portion 31B (second spring portion), a load bent portion 33B (second load bent portion), and bent portions 35B and 37B (second bent portions).

The load beam 30B is elastically supported on the surface 27 by the spring portion 31B. The load beam 30B is inclined by the load bent portion 33B in a direction different from the direction in which the load beam 30A is inclined. The load bent portion 33B has a second angle θ2.

The second angle θ2 of the load bent portion 33B is, for example, a counterclockwise angle with respect to the spring portion 31B, when viewed in the second direction Y. In the present embodiment, the second angle θ2 is equal to the first angle θ1. As illustrated in FIG. 3, the load beam 30B is inclined downward in the first direction X. From another point of view, as illustrated in FIG. 3, the load beams 30A and 30B are inclined by the load bent portions 33A and 33B to become apart from each other in the first direction X.

Thus, the slider 11 mounted on the suspension element SA1 can read data from and write data to the disk 4 different from that of the slider 11 mounted on the suspension element SA2.

The bent portions 35B and 37B are formed at both side portions 350 and 370 of the load beam 30B, and extends in the first direction X. When the focus is on the suspension element SA1, the bent portions 35B and 37B face the bent portions 35A and 37A of the load beam 30A as illustrated in FIG. 4.

In the example illustrated in FIG. 4, the distance W1 in the second direction Y between the bent portions 35A and 37A is equal to the distance in the second direction Y between the bent portions 35B and 37B. The distance W1 gradually becomes smaller in the first direction X.

The bent portions 35A and 37A are arranged at a distance from the bent portions 35B and 37B in the third direction Z. In other words, a gap G1 is formed between the bent portions 35A and 37A and the bent portions 35B and 37B. As illustrated in FIG. 3, the size of the gap G1 gradually becomes larger in the first direction X.

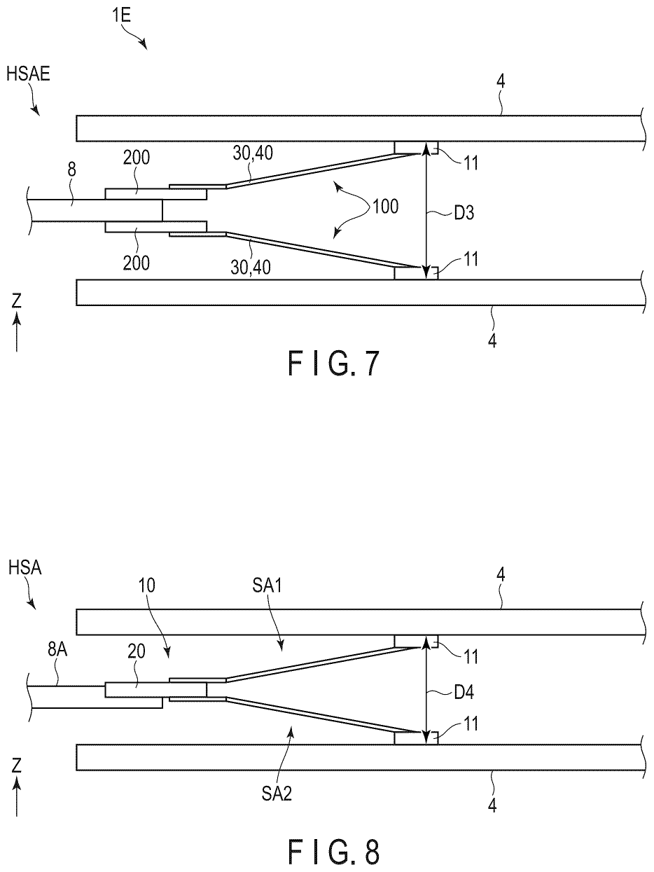

FIG. 6 is a schematic partial enlarged view illustrating the vicinity of the distal end portion of an arm 8 of a disk drive 1E according to a comparative example. FIG. 7 is a diagram illustrating the arrangement state of a head stack assembly HSAE and disks 4 in the disk drive 1E according to the comparative example. FIG. 8 is a diagram illustrating the arrangement state of the head stack assembly HSA and the disks 4 in the disk drive 1 according to the present embodiment.

In the disk drive 1E according to the comparative example, two suspensions 100 are attached to the arm 8. More specifically, the suspensions 100 are attached to the arm 8 from the third direction Z and the direction opposite to the third direction Z, respectively.

As illustrated in FIG. 7, sliders 11 are mounted on the distal end sides of the suspensions 100, respectively. The suspensions 100 each comprise a base plate 200, a load beam 30 and a flexure 40. As described above, the suspensions 100 (illustrated in FIG. 2) are attached to the arms 8 in the present embodiment as well.

The base plates 200 each comprise a boss portion and a surface 250. For example, the thickness of the base plates 200 is equal to the thickness of the base member 20. The load beams 30 have the same structure of that of the above-described load beams 30A and 30B. The flexures 40 have the same structure as that of the above-described flexures 40A and 40B. The load beams 30 are attached to the surfaces 250 of the base plates 200.

As illustrated in FIG. 6, the two base plates 200 are attached to the arm 8. Thus, a base fixing portion 810 of the arm 8 in the comparative example has a thickness greater than that of the base fixing portion 81 in the present embodiment.

Here, the distance between the surface 25 and the surface 27 of the base member 20 in the present embodiment is defined as a distance D1 (illustrated in FIG. 3), and the distance between the surfaces 250 of the base plates 200 in the comparative example is defined as a distance D2 (illustrated in FIG. 7). The distances D1 and D2 correspond to the distance between the spring portions of the load beams. The distance D1 is shorter than the distance D2 (D1<D2).

When the focus is on the head stack assembly HSA, the thickness DH (illustrated in FIG. 2) of the head stack assembly HSA can be reduced by reducing the distance D1. In particular, if the number of arms 8A increases, the thickness can be reduced more.

It is here assumed that the angles of the respective load bent portions of the load beams 30, 30A, and 30B are equal. In this case, the distance between the sliders 11 can be reduced by reducing the distance D1.

The distance between the sliders 11 in the comparative example is defined as a distance D3 (illustrated in FIG. 7), and the distance between the sliders 11 in the present embodiment is defined as a distance D4 (illustrated in FIG. 8). As described above, the distance D4 is shorter than the distance D3 (D4<D3).

The distance between the disks 4 can be reduced by reducing the distance D4. That is, the distance between the disks 4 in the present embodiment is shorter than the distance between the disks 4 in the comparative example.

Accordingly, if the same number of disks 4 are disposed, the present embodiment can reduce the thickness of the disk drive 1. In other words, in the structure of the present embodiment, a larger number of disks 4 can be disposed in the case 2 having the same thickness than in the disk drive 1E according to the comparative example.

In addition, reducing the distance D1 can form, for example, a sufficient gap between the disks 4 and the suspension structure 10, when the head stack assembly HSA is located between the disks 4. This makes it hard for the head stack assembly HSA to make contact with the disks 4.

In the present embodiment, the suspension elements SA1 and SA2 are each attached to the base member 20. Thus, the number of members for attaching the load beams can be reduced, compared to the head stack assembly HSAE of the comparative example. This can suppress the cost of the members.

Moreover, reducing the number of members for attaching the load beams also allows the thickness of the base member 20 to be increased. This can improve the stiffness of the base member 20. As a result, the resonance characteristics and load stability as the suspension elements SA1 and SA2 can be improved.

Furthermore, reducing the number of members for attaching the load beams also allows the height of the boss portion 29 to be increased. The base member 20 thereby can be stably attached to the arm 8A. As a result, the resonance characteristics and load stability as the suspension elements SA1 and SA2 can be improved.

In the present embodiment, the load directions can be unified, when the base member 20 is attached to the arm 8A in the manufacturing process. More specifically, in swaging, the direction in which the ball passes through the through-hole 29a can be set to a single direction (for example, the direction opposite to the third direction Z).

In this case, too, the base member 20 can be stably attached to the arm 8A. As a result, the resonance characteristics and load stability as the suspension elements SA1 and SA2 can be improved.

As described above, the structure of the present embodiment can provide the disk drive suspension structure 10 which can be made thinner. In particular, the present embodiment can make the head stack assembly HSA thinner. The disk drive 1 comprising the above-described disk drive suspension structure 10 can be made thinner. In addition to the above-described effects, the present embodiment can achieve various favorable effects.

While the example of the suspension structure 10 being attached to the one arm 8A of the arms 8 of the carriage 6 has been disclosed in the present embodiment, the suspension structure 10 may be attached to each of the arms 8 of the carriage 6.

Other embodiments will be described next. In the other embodiments described below, the same structural elements as those of the above-described first embodiment are assigned the same reference symbols as those of the first embodiment, and their detailed description may be omitted or simplified.

### SECOND EMBODIMENT

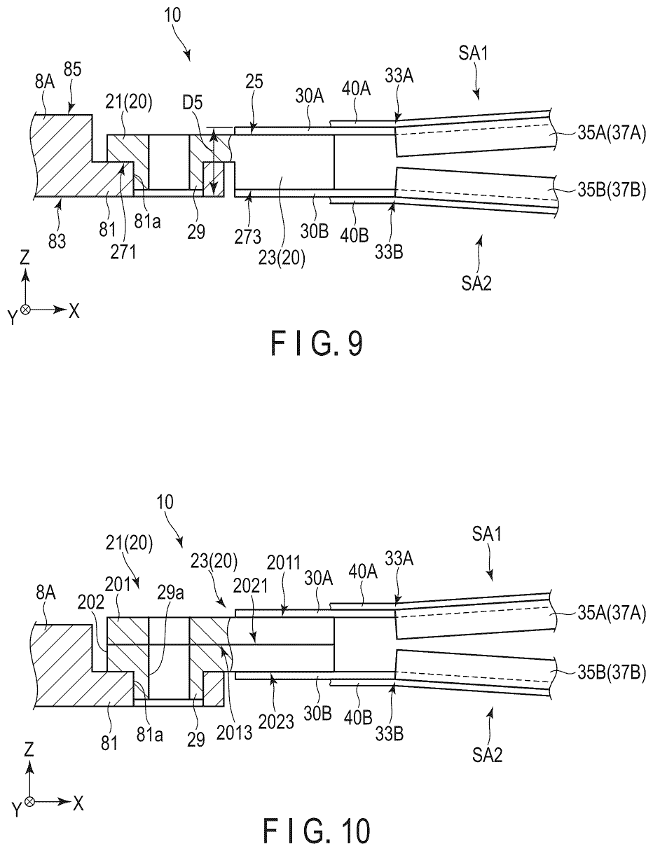

FIG. 9 is a schematic partial enlarged view illustrating the vicinity of the distal end portion of the arm 8A in the disk drive 1 according to the present embodiment. In the present embodiment, the shape of the base member 20 is different from that of the first embodiment.

The base member 20 comprises the base portion 21 and the attachment portion 23. The thickness of the attachment portion 23 is different from the thickness of the base portion 21. In the example illustrated in FIG. 9, the thickness of the attachment portion 23 is greater than the thickness of the base portion 21.

In comparison with the first embodiment, the thickness of the base portion 21 is smaller than the thickness of the base member 20 in the first embodiment, and the thickness of the attachment portion 23 is equal to the thickness of the base member 20 in the first embodiment.

The base member 20 comprises the surface 25 and surfaces 271 and 273 located on the opposite side. The surface 271 is located on the base portion 21, and the surface 273 is located on the attachment portion 23. In the present embodiment, the surface 25 corresponds to a first attachment surface, the surface 271 corresponds to a first surface, and the surface 273 corresponds to a second attachment surface.

The surface 271 and the surface 273 are parallel to the X-Y plane. The surface 271 faces the arm 8A, and the boss portion 29 is formed on the surface 271. As illustrated in FIG. 9, the surface 273 is located lower than the surface 271.

In other words, the surface 273 is shifted further in the direction opposite to the third direction Z than the surface 271. The load beam 30A is attached to the surface 25 of the base member 20, and the load beam 30B is attached to the surface 273 of the base member 20.

When the focus is on the relationship with the arm 8A, the surface 273 is located higher than a lower surface 83 of the arm 8A, and the surface 25 is located lower than an upper surface 85 of the arm 8A. In addition, the spring portion 31A of the load beam 30A is located lower than the upper surface 85.

The structure of the present embodiment also can achieve the same effects as those of the first embodiment. Moreover, in the present embodiment, the positions of the spring portions 31A and 31B are shifted in the direction opposite to the third direction Z, compared to the first embodiment, by changing the thickness of the attachment portion 23 and the thickness of the base portion 21 as described above.

Accordingly, the distance D5 (illustrated in FIG. 9) from the lower surface 83 to the load beam 30A can be made shorter than in the first embodiment. As a result, it becomes hard for the suspension structure 10 to make contact with the disks 4, when the arm 8A is located between the disks 4.

Furthermore, in the present embodiment, the positions of the sliders 11 (illustrated in FIG. 8) can be shifted in the third direction Z or the direction opposite to the third direction Z, compared to the first embodiment. For example, in the example illustrated in FIG. 9, the positions of the positions of the sliders 11 can be shifted in the direction opposite to the third direction Z, compared to the first embodiment.

### THIRD EMBODIMENT

FIG. 10 is a schematic partial enlarged view illustrating the vicinity of the distal end portion of the arm 8A in the disk drive 1 according to the present embodiment. The present embodiment differs from the first embodiment in that the base member 20 is composed of a plurality of members.

The base member 20 comprises a member 201 and a member 202 overlapping the member 201. In the present embodiment, the member 201 corresponds to a first member, and the member 202 corresponds to a second member. The member 201 is, for example, fixed to the member 202 by spot welding using a laser.

The member 201 and the member 202 each have the shape of a plate. The size of the member 201 is approximately equal to that of the member 202 when viewed in the third direction Z. The base portion 21 and the attachment portion 23 of the base member 20 are composed of the member 201 and the member 202.

The member 201 comprises a surface 2011 and a surface 2013 on the opposite side of the surface 2011. The member 202 comprises a surface 2021, a surface 2023 on the opposite side of the surface 2021, and the boss portion 29.

In the present embodiment, the surface 2011 corresponds to a first attachment surface, and the surface 2023 corresponds to a second attachment surface. The surface 2013 faces the surface 2021. On the surface 2023, the boss portion 29 is formed. The load beam 30A is attached to the surface 2011 of the member 201, and the load beam 30B is attached to the surface 2023 of the member 202.

The structure of the present embodiment also can achieve the same effects as those of the first embodiment. In addition, in the present embodiment, the base member 20 comprises the member 201 and the member 202.

In the manufacturing process, the load beam 30A is attached to the surface 2011 of the member 201, and the load beam 30B is attached to the surface 2023 of the member 202. After that, the load bent portions 33A and 33B of the load beams 30A and 30B are each formed.

Then, after the process of joining the member 201 and the member 202 together, the suspension structure 10 is attached to the arm 8A. As described above, since the load beams 30A and 30B are attached to separate members, the load bent portions 33A and 33B are easily processed. As a result, the present embodiment can improve the productivity of the manufacture of the suspension structure 10.

### FOURTH EMBODIMENT

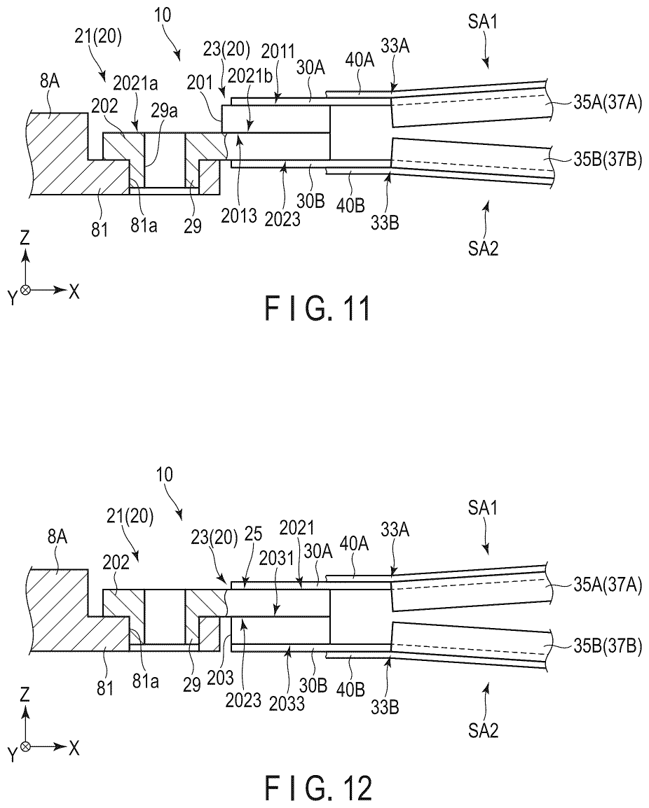

FIG. 11 is a schematic partial enlarged view illustrating the vicinity of the distal end portion of the arm 8A in the disk drive 1 according to the present embodiment. In the present embodiment, the shape of the member 201 is different from that of the third embodiment.

In the present embodiment, the base portion 21 of the base member 20 is composed of the member 202, and the attachment portion 23 is composed of the member 201 and the member 202. In other words, the member 201 does not overlap, for example, the boss portion 29 of the member 202. As illustrated in FIG. 11, the length in the first direction X of the member 201 is shorter than the length in the first direction X of the member 202.

The surface 2021 of the member 202 comprises a surface 2021a not overlapping the member 201 and a surface 2021b facing the member 201. The surface 2021b is connected to the surface 2021a. In the present embodiment, the surface 2021a corresponds to a third surface, and the surface 2021b corresponds to a fourth surface.

The structure of the present embodiment also can achieve the same effects as those of the third embodiment. In addition, in the present embodiment, the length of the member 201 in the first direction X is shorter than that of the third embodiment. Thus, the mass of the base member 20 can be made smaller than that of the base member 20 in the third embodiment.

That is, the mass of the head stack assembly HSA can be made smaller than the mass of the head stack assembly HSA in the third embodiment. As a result, the responsiveness of the head stack assembly HSA can be improved.

### FIFTH EMBODIMENT

FIG. 12 is a schematic partial enlarged view illustrating the vicinity of the distal end portion of the arm 8A in the disk drive 1 according to the present embodiment. The present embodiment differs from the second embodiment in that the attachment portion 23 of the base member 20 is composed of a plurality of members.

The base member 20 comprises the member 202 and a member 203 overlapping the member 202. In the present embodiment, the member 202 corresponds to a third member, and the member 203 corresponds to a fourth member. The member 203 is, for example, fixed to the member 202 by spot welding using a laser.

In the present embodiment, the base portion 21 of the base member 20 is composed of the member 202, and the attachment portion 23 is composed of the member 202 and the member 203. The member 203 does not overlap, for example, the boss portion 29 of the member 202. In other words, the member 203 and the boss portion 29 are arranged in the first direction X.

The member 203 has the shape of a plate. As illustrated in FIG. 12, the length in the first direction X of the member 203 is shorter than the length in the first direction X of the member 202.

The member 203 comprises a surface 2031 facing the surface 2023, and a surface 2033 on the opposite side of the surface 2031. In the present embodiment, the surface 2021 corresponds to a first attachment surface, and the surface 2033 corresponds to a second attachment surface. The load beam 30A is attached to the surface 2021 of the member 202, and the load beam 30B is attached to the surface 2033 of the member 203.

As illustrated in FIG. 12, the surface 2033 is located lower than the surface 2021. In other words, the surface 2033 is shifted further in the direction opposite to the third direction Z than the surface 2021.

The structure of the present embodiment also can achieve the same effects as those of the second embodiment. In addition, in the present embodiment, since the load beams 30A and 30B are attached to separate members, the load bent portions 33A and 33B are easily processed.

### SIXTH EMBODIMENT

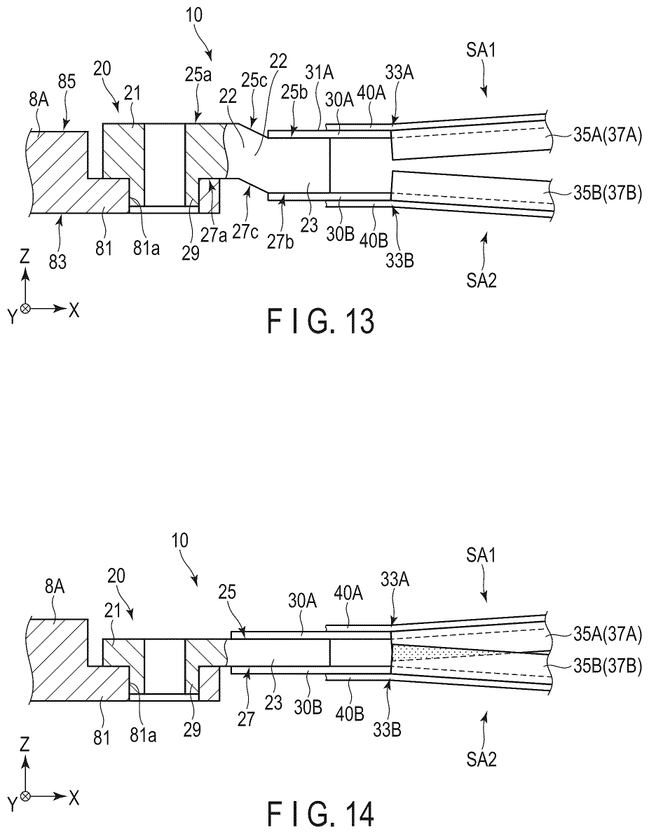

FIG. 13 is a schematic partial enlarged view illustrating the vicinity of the distal end portion of the arm 8A in the disk drive 1 according to the present embodiment. In the present embodiment, the shape of the base member 20 is different from that of the first embodiment.

The base member 20 further comprises a step portion 22 formed between the base portion 21 and the attachment portion 23. The base portion 21, the attachment portion 23, and the step portion 22 are, for example, uniform in thickness. The surface 25 of the base member 20 comprises a surface 25a located on the base portion 21, a surface 25b located on the attachment portion 23, and a surface 25c located on the step portion 22.

The surface 27 of the base member 20 comprises a surface 27a located on the base portion 21, a surface 27b located on the attachment portion 23, and a surface 27c located on the step portion 22. The surface 27a faces the arm 8A, and the boss portion 29 is formed on the surface 27a.

In the present embodiment, the surface 25a corresponds to a second surface, the surface 25b corresponds to a first attachment surface, the surface 27a corresponds to a first surface, and the surface 27b corresponds to a second attachment surface. The surfaces 25a, 25b, 27a, and 27b are parallel to the X-Y plane. The load beam 30A is attached to the surface 25b of the base member 20, and the load beam 30B is attached to the surface 27b of the base member 20.

The surfaces 25c and 27c are, for example, inclined surfaces inclined with respect to the first direction X. In the present embodiment, the surface 25c corresponds to a second inclined surface, and the surface 27c corresponds to a first inclined surface. More specifically, as illustrated in FIG. 13, the surfaces 25c and 27c are inclined downward in the first direction X.

Thus, the surface 25b is located lower than the surface 25a, and the surface 27b is located lower than the surface 27a. In other words, the surface 25b is shifted further in the direction opposite to the third direction Z than the surface 25a, and the surface 27b is shifted further in the direction opposite to the third direction Z than the surface 27a.

When the focus is on the relationship with the arm 8A, the surface 27b is located higher than the lower surface 83 of the arm 8A, and the surface 25b is located lower than the upper surface 85 of the arm 8A. In addition, the spring portion 31A of the load beam 30A is located lower than the upper surface 85.

The structure of the present embodiment also can achieve the same effects as those of the first and second embodiments. Note that the shape of the step portion 22 is not limited to the example illustrated in FIG. 13.

### SEVENTH EMBODIMENT

FIG. 14 is a schematic partial enlarged view illustrating the vicinity of the distal end portion of the arm 8A in the disk drive 1 according to the present embodiment. In the present embodiment, the thickness of the base member 20 is different from that of the first embodiment.

More specifically, the thickness of the base member 20 is smaller than that of the base member 20 in the first embodiment. Thus, at least part of the load beam 30A overlaps the load beam 30B when viewed in the second direction Y. That is, the base member 20 has a thickness that causes at least part of the load beam 30A to overlap the load beam 30B.

More specifically, the bent portions 35A and 37A overlap the bent portions 35B and 37B, when viewed in the second direction Y. In FIG. 14, the region where the bent portions 35A and 37A overlap the bent portions 35B and 37B when viewed in the second direction Y is patterned with dots. The region where the bent portions 35A and 37A overlap the bent portions 35B and 37B gradually becomes smaller in the first direction X.

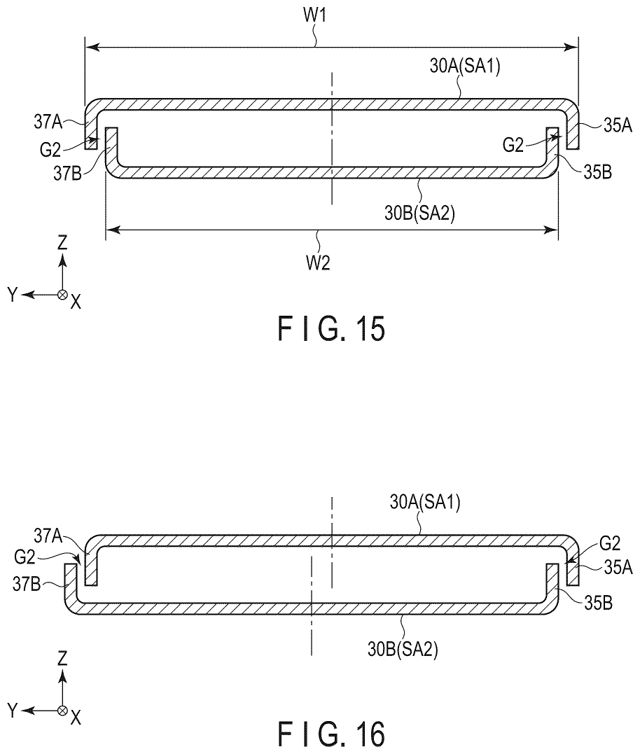

FIG. 15 and FIG. 16 are diagrams illustrating examples of the arrangement state of the load beams 30A and 30B of the suspension structure 10 in the present embodiment.

In the example illustrated in FIG. 15, the distance W1 in the second direction Y between the bent portions 35A and 37A is different from the distance W2 in the second direction Y between the bent portions 35B and 37B. More specifically, the distance W1 in the second direction Y between the bent portions 35A and 37A is longer than the distance W2 in the second direction Y between the bent portions 35B and 37B.

The load beam 30B is located between the bent portions 35A and 37A of the load beam 30A in the second direction Y. The distance W1 in the second direction Y between the bent portions 35A and 37A may be shorter than the distance W2 in the second direction Y between the bent portions 35B and 37B.

In the example illustrated in FIG. 16, the distance W1 in the second direction Y between the bent portions 35A and 37A is equal to the distance in the second direction Y between the bent portions 35B and 37B. The center in the second direction Y of the load beam 30A is shifted from the center in the second direction Y of the load beam 30B.

More specifically, the load beam 30B is shifted toward the left side in the figure (in the second direction Y) with respect to the center of the load beam 30A. The load beam 30B may be shifted toward the right side in the figure (in the direction opposite to the second direction Y) with respect to the center of the load beam 30A. In the example illustrated in FIG. 16, too, the distance W1 in the second direction Y between the bent portions 35A and 37A may be different from the distance in the second direction Y between the bent portions 35B and 37B as in the example illustrated in FIG. 15.

In the examples illustrated in FIG. 15 and FIG. 16, a gap G2 is formed between the bent portions 35A and 37A and the bent portions 35B and 37B in the second direction Y. With the arrangement state in the examples illustrated in FIG. 15 and FIG. 16, it is hard for the load beams 30A and 30B to interfere with each other, even if the thickness of the base member 20 is reduced.

The structure of the present embodiment also can achieve the same effects as those of the first embodiment. Moreover, the present embodiment can further reduce the thickness of the base member 20. The structure of the present embodiment can be applied to each of the above-described embodiments as well.

### EIGHTH EMBODIMENT

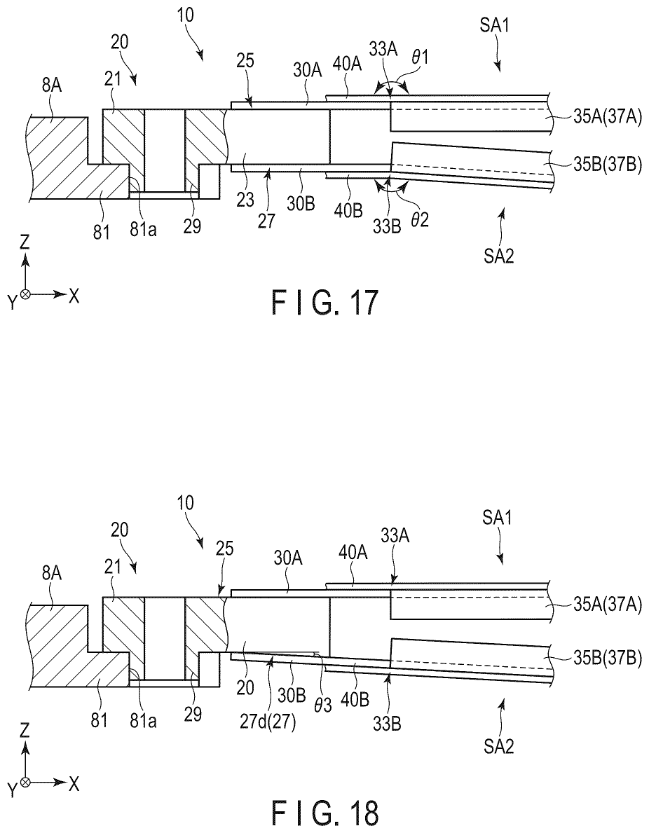

FIG. 17 is a schematic partial enlarged view illustrating the vicinity of the distal end portion of the arm 8A in the disk drive 1 according to the present embodiment. The present embodiment differs from the first embodiment in that the first angle θ1 of the load bent portion 33A of the load beam 30A is different from the second angle θ2 of the load bent portion 33B of the load beam 30B.

In the example illustrated in FIG. 17, the second angle θ2 of the load bent portion 33B is smaller than the first angle θ1 of the load bent portion 33A. The first angle θ1 of the load bent portion 33A is large, compared to that of the first embodiment. In contrast, the second angle θ2 of the load bent portion 33B is small, compared to that of the first embodiment.

The structure of the present embodiment also can achieve the same effects as those of the first embodiment. In addition, in the present embodiment, the positions of the sliders 11 (illustrated in FIG. 8) can be shifted in the third direction Z or the direction opposite to the third direction Z, compared to the first embodiment, by adjusting the first angle θ1 and the second angle θ2. For example, in the example illustrated in FIG. 17, the positions of the sliders 11 can be shifted in the direction opposite to the third direction Z, compared to the first embodiment.

In addition, the distance between the disks 4 can be adjusted in accordance with the first angle θ1 of the load bent portion 33A and the second angle θ2 of the load bent portion 33B. The structure of the present embodiment can be applied to each of the above- described embodiments as well.

### NINTH EMBODIMENT

FIG. 18 is a schematic partial enlarged view illustrating the vicinity of the distal end portion of the arm 8A in the disk drive 1 according to the present embodiment. In the present embodiment, the shape of the base member 20 is different from that of the first embodiment.

The surface 27 comprises a surface 27d located on the attachment portion 23. In the present embodiment, the surface 25 corresponds to a first attachment surface, and the surface 27d corresponds to a second attachment surface. The load beam 30A is attached to the surface 25 of the base member 20, and the load beam 30B is attached to the surface 27d of the base member 20.

The surface 27d is an inclined surface inclined with respect to the surface 25. More specifically, the surface 27d is inclined with respect to the surface 25 such that its distance from the surface 25 in the third direction Z increases in the first direction X. An angle θ3 of the surface 27d with respect to the first direction X can be changed as appropriate in accordance with the distance between the disks 4. In addition, the first angle θ1 of the load bent portion 33A (illustrated in FIG. 3) may be equal to or may be different from the second angle θ2 of the load bent portion 33B (illustrated in FIG. 3).

The structure of the present embodiment also can achieve the same effects as those of the first embodiment. Moreover, in the present embodiment, the positions of the sliders 11 (illustrated in FIG. 8) can be shifted further in the third direction Z or the direction opposite to the third direction Z, compared to the first embodiment, by adjusting the angle θ3 of the surface 27d with respect to the first direction X.

For example, in the example illustrated in FIG. 18, the positions of the sliders 11 can be shifted in the direction opposite to the third direction Z, compared to the first embodiment. In addition, the distance between the disks 4 can be adjusted in accordance with the angle θ3 of the surface 27d with respect to the first direction X.

While the case where the surface 27 comprises an inclined surface has been described in the present embodiment, the surface to which the load beam 30A is attached of the surface 25 may be inclined, or the surfaces to which the load beams 30A and 30B are attached may be each inclined. The structure of the present embodiment can be applied to each of the above-described embodiments as well.

### TENTH EMBODIMENT

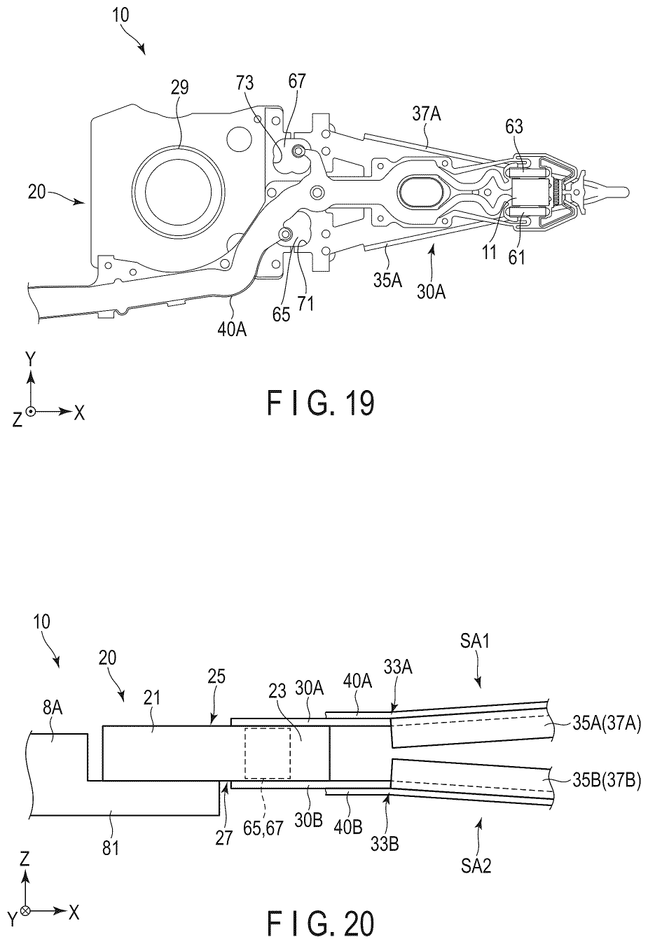

FIG. 19 is a schematic plan view illustrating an example of the suspension structure 10 according to the present embodiment. FIG. 20 is a schematic partial enlarged view illustrating the vicinity of the distal end portion of the arm 8A in the disk drive 1 according to the present embodiment. The present embodiment differs from the first embodiment in that actuator elements 65 and 67 are mounted on the base member 20.

In the example illustrated in FIG. 19, the suspension structure 10 comprises the actuator elements 61 and 63 mounted on the distal end side, and the actuator elements 65 and 67 mounted on the base member 20.

In the base member 20, apertures 71 and 73 (illustrated in FIG. 19) for mounting the actuator elements 65 and 67 are formed in the attachment portion 23. In the present embodiment, the apertures 71 and 73 correspond to actuator mounting portions.

The apertures 71 and 73 are formed between the surface 25 and the surface 27. More specifically, the apertures 71 and 73 penetrate the surface 25 and the surface 27. When the focus is on the suspension elements SA1 and SA2, the actuator elements 65 and 67 are located between the load beams 30A and 30B as illustrated in FIG. 19.

The structure of the present embodiment also can achieve the same effects as those of the first embodiment. Moreover, in the present embodiment, the actuator elements 65 and 67 are mounted on the base member 20. The actuator elements 65 and 67 thereby act on the suspension elements SA1 and SA2, respectively.

As described above, since it is unnecessary to mount actuator elements on the suspension elements SA1 and SA2, respectively, the number of actuator elements to be mounted can be reduced. This can suppress the cost of the members.

In carrying out each of the above-described embodiments, various changes can be made to the specific form of each element constituting the disk drive, as well as to specific forms such as the shapes of the arms, the base member, the load beams, the flexures, and the like.

Various embodiments can be formed by combining structural elements disclosed in each of the above-described embodiments as appropriate. For example, several structural elements may be deleted from all structural elements disclosed in each of the embodiments. Furthermore, structural elements in different embodiments may be combined as appropriate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive suspension structure attached to an arm of a disk drive, the disk drive suspension structure comprising:
a base member comprising a base portion and an attachment portion connected to the base portion, the base portion comprising a boss portion attached to the arm, the attachment portion comprising a first attachment surface facing in a direction opposite to a projection direction of the boss portion and a second attachment surface facing in the projection direction of the boss portion;
a first load beam attached to the first attachment surface; and
a second load beam attached to the second attachment surface and facing the first load beam.

2. The disk drive suspension structure of claim 1, wherein the first load beam comprises first bent portions formed at both side portions of the first load beam, respectively, and extending in a longitudinal direction of the first load beam, and
the second load beam comprises second bent portions formed at both side portions of the second load beam, respectively, extending in the longitudinal direction, and facing the first bent portions.

3. The disk drive suspension structure of claim 1, wherein the base portion comprises a first surface on which the boss portion is formed and which faces the arm, and
the second attachment surface is shifted further in the projection direction than the first surface.

4. The disk drive suspension structure of claim 3, wherein the base portion further comprises a second surface on an opposite side of the first surface, and
the first attachment surface is shifted further in the projection direction than the second surface.

5. The disk drive suspension structure of claim 4, wherein the base member further comprises a step portion formed between the base portion and the attachment portion,
wherein the step portion comprises:
a first inclined surface connecting the first surface and the second attachment surface; and
a second inclined surface connecting the second surface and the first attachment surface.

6. The disk drive suspension structure of claim 1, wherein the base member comprises:
a first member comprising the first attachment surface; and
a second member comprising the boss portion and the second attachment surface and overlapping the first member.

7. The disk drive suspension structure of claim 6, wherein the second member comprises:
a third surface not overlapping the first member; and
a fourth surface connected to the third surface and facing the first member, and
the third surface and the fourth surface are located on an opposite side of the second attachment surface.

8. The disk drive suspension structure of claim 1, wherein the base member comprises:
a third member comprising the boss portion and the first attachment surface; and
a fourth member comprising the second attachment surface and overlapping the third member.

9. The disk drive suspension structure of claim 8, wherein the fourth member and the boss portion are arranged in the longitudinal direction of the first load beam.

10. The disk drive suspension structure of claim 2, wherein the first load beam comprises a first spring portion attached to the first attachment surface, and a first load bent portion formed in a width direction of the first load beam between the first spring portion and the first bent portions and having a first angle, and
the second load beam comprises a second spring portion attached to the second attachment surface, and a second load bent portion formed in the width direction between the second spring portion and the second bent portions and having a second angle different from the first angle.

11. The disk drive suspension structure of claim 10, wherein the second angle is smaller than the first angle.

12. The disk drive suspension structure of claim 1, wherein the second attachment surface is inclined with respect to the first attachment surface to increase a distance between the first attachment surface and the second attachment surface in a longitudinal direction of the first load beam.

13. The disk drive suspension structure of claim 1, wherein the first load beam comprises first bent portions formed at both side portions of the first load beam, respectively, and extending in a longitudinal direction of the first load beam,
the second load beam comprises second bent portions formed at both side portions of the second load beam, respectively, and extending in the longitudinal direction, a gap being formed between the first bent portions and the second bent portions in a width direction of the first load beam, and
the first bent portions overlap the second bent portions, when viewed in the width direction.

14. The disk drive suspension structure of claim 1, wherein the base member further comprises an actuator mounting portion formed between the first attachment surface and the second attachment surface.

15. The disk drive suspension structure of claim 14, wherein the actuator mounting portion is an aperture penetrating the first attachment surface and the second attachment surface.

16. A disk drive comprising:
the disk drive suspension structure of claim 1; and
the arm comprising a base fixing portion to which the base member is attached.
